(19) United States
(12) Patent Application Publication
(10) Pub. No.: US 2006/0081427 A1
(43) Pub. Date: Apr. 20, 2006

(54) Hydraulic antivibratory device for a vehicle, and a method of manufacturing such a device

(75) Inventors: Pierre Gautier, Bourges (FR); Bernard Bouhier, Noyers Sur Cher (FR); Pascal Carobolante, Saint Hilaire De Court (FR)

Correspondence Address: Thomas A. Miller;MILLER MATTHIAS & HULL, Suite 2350, One North Franklin Street, Chicago, IL, 60606, US

(73) Assignee: Hutchinson, Paris (FR)

(21) Appl. No.: 11/248,019

(22) Filed: Oct. 11, 2005

(30) Foreign Application Priority Data
Oct. 11, 2004 (FR) FR 04 10705

(51) Int. Cl. F16F 15/03

(52) U.S. Cl. 188/267

(57) ABSTRACT

A hydraulic antivibration device comprises an inner strength member and an outer strength member together with an elastomer body disposed between the inner and outer strength members. The elastomer body includes at least two sets of two hydraulic chambers the chambers in any one set intercommunicating via a duct in which a fluid flows. The device includes a window strength member disposed inside the elastomer body and including at least one plate element close to the outer strength member. The ducts interconnect two chambers of a given set via at least a portion situated between a plate element of the window strength member and the outer strength member, and include walls formed by the elastomer body.

### BACKGROUND OF THE INVENTION

The present invention relates to antivibration devices.

More particularly, the invention relates to a hydraulic antivibration device comprising an inner strength member and an outer strength member that are coaxial about a longitudinal axis Z, an elastomer body disposed between the inner and outer strength members and interconnecting them, said body being secured to the inner strength member and co-operating with the outer strength member to form a leaktight assembly, the elastomer body including at least two sets of two hydraulic chambers, the chambers in any one set communicating with one another via a duct in which a fluid flows, at least one of the sets being for damping vibration in a direction selected from a radial direction and an axial direction.

### TECHNICAL ART

Document FR-2 659 712-A1 describes an example of a hydraulic antivibration sleeve of this type that includes two rigid inner strength members. Ducts are formed by grooves formed in the thickness of a first inner strength member. A second inner strength member is engaged on the first to close the longitudinal opening of each groove.

A particular object of the present invention is to simplify the manufacture of that type of sleeve.

### DISCLOSURE OF THE INVENTION

To this end, according to the invention, a device of the kind in question is characterized in that:

it includes a window strength member disposed inside the elastomer body and comprising at least one plate element close to the outer strength member; and

the ducts interconnect pairs of chambers of each set over at least a portion situated between a plate element of the window strength member and the outer strength member, and comprise walls formed by the elastomer body.

By means of these dispositions, it is no longer necessary to provide an inner strength member in order to form the ducts therein. In the embodiment of the sleeve of the invention as defined above, the ducts are made in the vicinity of the outer strength member which closes the grooves formed in the elastomer body. Instead of machining grooves in a metal part constituting an inner strength member for each sleeve, the grooves are formed on a single occasion only, while forming the mold.

In various embodiments of the device of the invention, recourse may optionally also be had to one or more of the following dispositions:

the chambers are rectilinear and pass through the elastomer body in a direction that is parallel to a transverse axis X perpendicular to the longitudinal axis;

the window strength member presents windows defining a section of the chambers;

the device comprises:
at least one first set of two chambers interconnected by a first duct extending essentially parallel to the longitudinal axis Z, for damping vibration in the axial direction;
at least one second set of two chambers interconnected by a second duct extending essentially in a plane perpendicular to the longitudinal axis Z for damping vibration in a radial direction; and
two distinct plate elements, the first and second ducts each passing between a distinct plate element and the outer strength member;
in the present document, a plate element corresponds to a portion of the surface of the window strength member. These plate elements may be at 180° relative to each other, for example, about the longitudinal axis Z;

the first and second ducts are diametrically opposite each other;

elastomer beads run along at least a portion of each duct, in order to reinforce the sealing properties of the duct;

each chamber of a first set extends longitudinally parallel to a midplane and perpendicularly to the longitudinal axis Z, and is symmetrical to the other chamber about said midplane, and each chamber of a second set extends longitudinally essentially in the midplane, and is symmetrical to the other chamber about the axis Z;

the device has two sets of chambers for damping in an axial direction, these two sets being diametrically opposite and disposed in the vicinity of the longitudinal ends of the device, the ducts interconnecting the two chambers in each set extending essentially along the longitudinal axis;

the window strength member comprises at least two semicylindrical metal plates assembled together by staking;

the window strength member includes a metal structure on which plate elements made of plastics material are fitted;

the window strength member comprises two cylindrical metal plates assembled together by welding;

the window strength member presents at least one U-shaped bearing zone having limbs adjacent to the chambers;

the bearing zone is formed by a projecting portion directed towards the inside of the plate elements made of plastics material; and

the strength member is made entirely out of plastics material.

Furthermore, the invention also provides a method of manufacturing the device as defined above, which method is characterized by the fact that a window strength member is placed in a mold together with the inner strength member, and that the mold is made up of at least two parts, at least one of the parts including at least one finger, and, on being closed, the mold is adapted to form at least two chamber-forming recesses and at least one duct interconnecting the two chambers, said duct having at least one portion situated between the window strength member and the outer strength member.

This method includes an unmolding operation during which the two mold parts are moved apart along a direction perpendicular to the axial direction.

Other characteristics and advantages of the invention appear from the following description of two embodiments thereof, given as non-limiting examples and with reference to the accompanying drawings.

### BRIEF DESCRIPTION OF THE DRAWINGS

In the drawings:

FIG. 1 is a longitudinal section view of a first embodiment of the device of the invention;

FIG. 2 is a perspective view cut away on two perpendicular planes of the device shown in FIG. 1;

FIG. 3 is a side elevation view of the device of FIGS. 1 and 2 without the outer strength member;

FIG. 4 is a view analogous to FIG. 3 in which the device has been turned through 180° about the longitudinal axis Z;

FIG. 5 is a perspective view of the window strength member of the device shown in FIGS. 1 to 4;

FIG. 6 is a view similar to FIG. 2 showing a device constituting a second embodiment;

FIG. 7 is a perspective view of the window strength member in the second embodiment of the device;

FIG. 8 is a perspective view of a variant embodiment of the window strength member of the device constituting the second embodiment;

FIG. 9 is a view of the inside face of a mold shell for making the device constituting the first embodiment; and

FIG. 10 is a view of the inside face of a mold shell for making the device of the second embodiment.

### DETAILED DESCRIPTION

In the figures, the same references are used to designate elements that are identical or similar.

A first embodiment is described below with reference to FIGS. 1 to 5.

In the description below, reference is made to two transverse orientations and one longitudinal orientation, said orientations being specified by a right-handed, X, Y, Z coordinate system.

FIG. 1 is a section view of an embodiment of the antivibration device 10 of the invention, this device comprising an inner strength member 12 and an outer strength member 36 that are both cylindrical. The inner and outer strength members 12 and 36 are coaxial about a longitudinal axis Z. The inner and outer strength members 12 and 36 are made in conventional manner, e.g. out of aluminum.

A window strength member 34 is interposed between the inner strength member 12 and the outer strength member 36.

An elastomer body 14 is bonded to the inner strength member 12 and to the window strength member 34.

The window strength member 34 is cylindrical and centered on the axis Z. It is of a length that is slightly longer than the length of the outer strength member 36 and it has a curved end 38. Thus, the outer strength member 36 is engaged over, crimped to, and blocked on the window strength member 34, with an elastomer layer 44 being interposed between them. The curved end 38 blocks downward movement of the window strength member 34 relative to the outer strength member 36, and enables the device to be made leaktight.

As shown in FIG. 5, the window strength member 34 presents two metal plate elements 46 and 48 corresponding to cylindrical surface portions that are substantially parallel to the outer strength member 36 and each including a respective setback 50.

These two plate elements 46, 48 are the only component parts of the window strength member 34. They are formed by stamping and then assembled together by staking, i.e. by clamping and then by compression, along a direction parallel to the longitudinal axis Z.

In a variant embodiment of the window strength member 34, it may be constituted by a single piece that is stamped and then curved so that two longitudinal edges are moved towards each other and locked together by staking.

In another variant, the window strength member may be made up of four plate elements corresponding to respective cylindrical surface portions that are assembled to one another by staking in a direction parallel to the longitudinal axis Z.

The first plate element 46 is symmetrical to the other about the longitudinal axis Z. Each of the plate elements 46 or 48 includes a setback 50 presenting a U-shape in radial section and three bearing surfaces. Two of these bearing surfaces 52a and 52b correspond to the two limbs of the U-shape and are inclined at an acute angle relative to the axis Z. The third of these bearing surfaces 54 corresponds to the bottom of the U-shape and is substantially parallel to the axis Z.

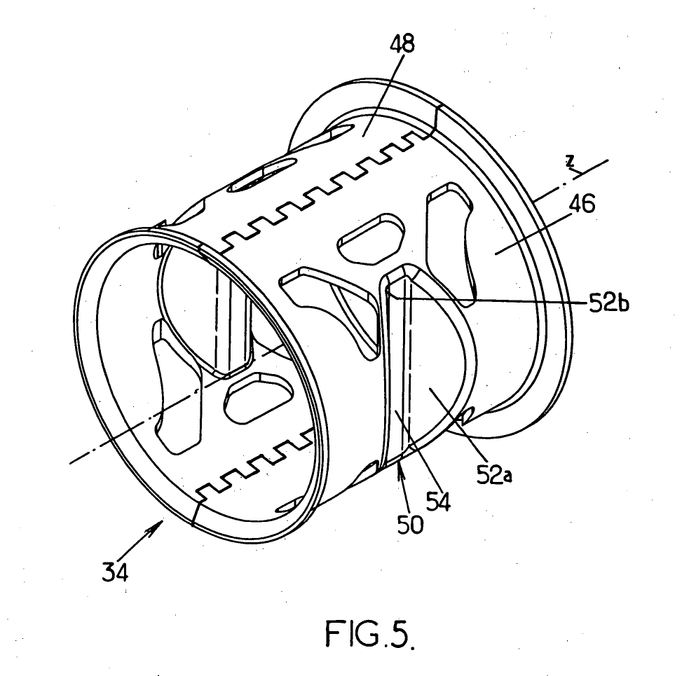

As shown in FIG. 3, chambers 16, 18, 20, 22, 24, and 26 are formed in the elastomer body 14. The chambers 16, 18, 20, 22, 24, and 26 are closed when the device 10 is assembled with the outer strength member 36.

The elastomer body 14 thus has six openings corresponding to the chambers 16, 18, 20, 22, 24, and 26. These openings are through openings and they are substantially rectilinear along a direction parallel to the axis X. They open out into a surface of the elastomer body 14 that is substantially cylindrical about the longitudinal axis Z.

The chambers 16 and 18 or 20 and 22, of the first and third sets, referred to as “axial” sets, are situated substantially in the vicinity of the longitudinal ends of the device 10. A second set of chambers 24 and 26, referred to as a “radial” set, is placed in the midplane of the device 10 perpendicularly to the longitudinal axis Z.

A chamber 16 or 18 of the first set and a chamber 20 or 22 of the third set, situated towards the same longitudinal end occupy a distal plane parallel to the midplane. The two distal planes are symmetrical about the midplane.

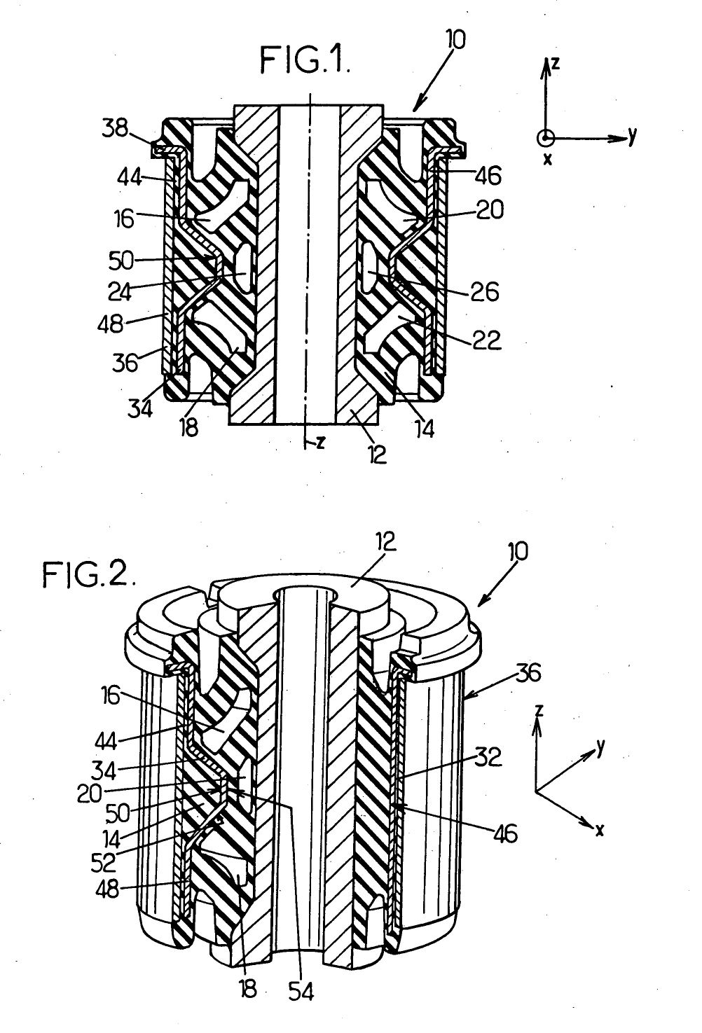

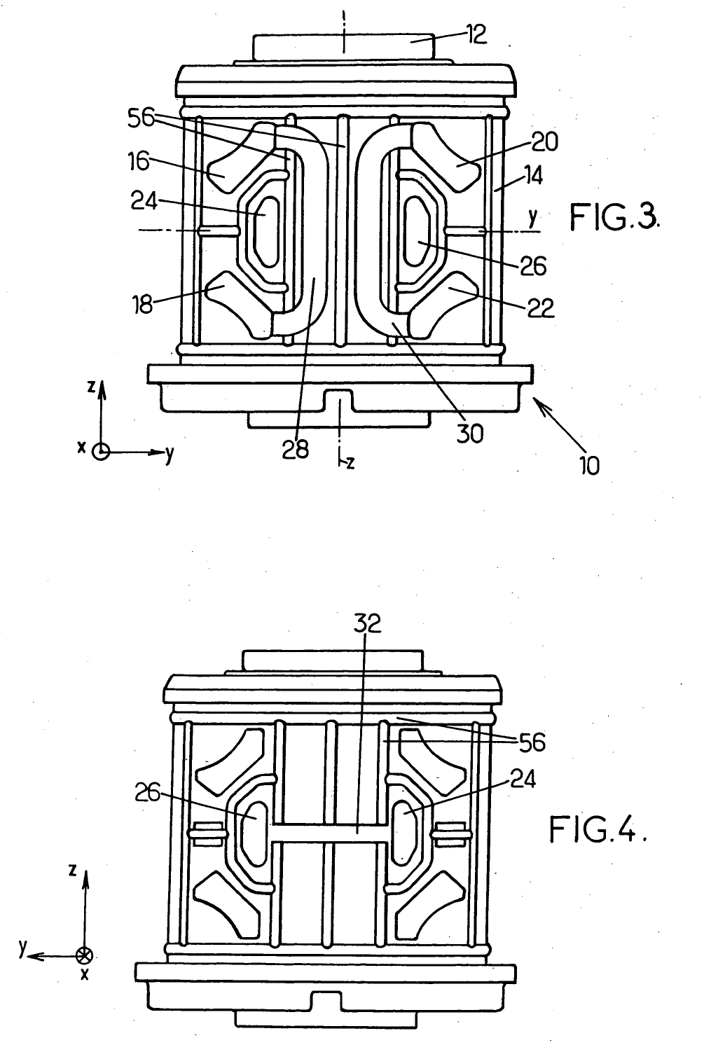

The chambers 16, 18, 20, and 22 of the axial sets present a section perpendicular to the axis X that is substantially polygonal, having one side close to a bearing surface 52 and extending substantially parallel thereto (see FIGS. 1 and 2). These chambers extend perpendicularly at their respective bearing surfaces 52, from said bearing surface 52 towards the inner strength member 12.

The bearing surfaces 52 serve to transmit forces applied axially along the longitudinal axis Z, or even radially along the axis Y, and to increase the deformation of the sections of the chambers, and thus to increase the variations in the volumes of the chambers 16 and 18, or 20 and 22 of the first or third sets, respectively.

The chambers 24 and 26 of the radial set present sections perpendicularly to the axis X that are substantially polygonal, each having one side substantially parallel to the third bearing surface 54.

The third bearing surface 54 enables forces applied radially relative to the longitudinal direction Z between the inner and outer strength members 12 and 36 to be transmitted to one of the chambers 24 or 26 of the second set.

As shown in FIG. 3, the two chambers 16 and 18 of the first set communicate with each other via a duct 28 extending essentially parallel to the longitudinal direction Z.

The two chambers 20 and 22 of the third set communicate with each other via a duct 30 extending essentially parallel to the direction Z.

As shown in FIG. 4, the two chambers 24 and 26 of the second set communicate with each other via a duct 32 extending in essentially circular manner in a midplane perpendicular to the longitudinal axis Z.

The ducts 28 and 30 of the first and third sets of chambers, and the duct 32 of the second set of chambers are situated level with diametrically-opposite plate elements.

The ducts 28, 30, and 32 are formed in the elastomer layer 44. The ducts 28, 30, and 32 thus have an inside wall formed by a fine layer of elastomer bonded to the window strength member 34, an outside wall formed by the outer strength member 36, and two sides formed in the thickness of the elastomer layer 44.

These ducts are quite leaktight, and they allow liquid to pass from one chamber to the other. To make them even more leaktight, beads 56 surround each of the ducts 28, 30, and 32. These beads 56 project from the outside surface of the elastomer body 14 when the outer strength member 36 is not in place on the window strength member 34. When the device 10 is assembled, the beads 56 are flattened between the outer strength member 36 and the window strength member 34, thereby providing sealing between the various chambers and ducts.

When the device 10 is assembled, the chambers 16, 18, 20, 22, 24, and 26 and the ducts 28, 30, and 32 are filled with a fluid, e.g. glycol. When the chambers are deformed, the fluid flows in each of said ducts 28, 30, or 32 between the corresponding chambers 16 and 18, 20 and 22, or 24 and 26. The displacement of the fluid between the two chambers in each set serves to contribute to damping vibration coming from the various stresses to which the device 10 is subjected, in the longitudinal direction Z, and in the radial direction Y.

The present invention thus operates as follows:

The inner strength member 12 and the outer strength member 36 are secured to elements that are subjected to vibration. The vibration is filtered firstly by the elastomer body 14 at high frequencies, and is damped secondly by the hydraulic chambers, at low frequencies. The relative oscillations applied axially along the longitudinal axis or radially to one of the strength members 12 and 36 give rise to alternating movements of liquid from one chamber to the other, and when the oscillations are at a predetermined frequency value, the liquid contained in the duct 28, 30, or 32 provides effective damping of the oscillations by a resonant effect at low frequencies.

The passage of fluid along the ducts 28, 30, or 32 takes place at a frequency and at a maximum amplitude. These characteristics are determined by the dimensions of each duct 28, 30, or 32, such as its section and its length. The damping of vibration between the inner and outer strength members 12 and 36 is at a maximum when the oscillations of the liquid are put into resonance. In addition, the deformation of the chambers is increased by the bearing surfaces 52 and 54 of the window strength member 34. These bearing surfaces act as pistons exerting pressure on one of the chambers in a set.

Radial damping is independent of axial damping, thus making it possible to absorb vibration coming from two different directions, without interference, and thus making it possible to determine the parameters of the ducts 28, 30, and 32 independently, in order to obtain a better result.

By means of the device constituting the embodiment of the invention described above, it is possible to obtain large axial strokes, e.g. of 6 millimeters (mm).

This type of device 10 can be applied in particular to a suspension for an engine. The outer strength member is then connected to the engine suspension arm, and the inner strength member is connected to the vehicle body, in order to damp vibration and prevent vibration being transmitted to the cabin.

The invention also provides a method of making a device as described above.

In an implementation of the method of the invention, the following steps are performed:

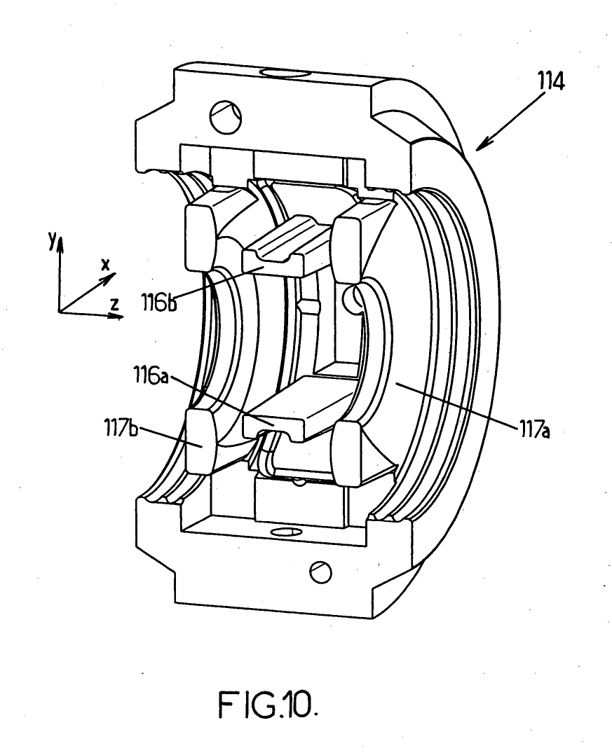

placing the inner strength member covered in adhesive together with the window strength member in a two-part mold, each part being formed by a semicylindrical shell 72 as shown in FIG. 9, for example;

injecting the elastomer body into the mold; and

separating the two mold parts after the elastomer has set.

The elastomer body is subjected to heat treatment for hardening it and bonding the elastomer body to the inner strength member in application of a method known to the person skilled in the art.

Thereafter, the outer strength member is engaged on the previously-obtained part while the part is immersed in a bath of liquid for the purpose of filling the chambers. Alternatively, the chambers could be filled by a vacuum-filling method known to the person skilled in the art. Finally, the outer strength member is swaged onto the elastomer body.

Each mold part has a defined number of fingers 74 depending on the number of chambers that are to be made. To prepare the mold, prior to injecting the elastomer, the semicylindrical shells 72 of the mold are moved towards each other so that the fingers 74 are placed facing one another and the ends of the fingers 74 are brought as close together as possible, or even into contact. The recesses defined by the fingers 74 then form the chambers.

In a particular implementation, the elastomer body is unmolded in a direction parallel to the fingers 74, perpendicularly to the Y-Z plane, thus making it possible to have chambers that open out into the cylindrical surface of the elastomer body. This characteristic makes it possible to obtain greater deformation for the openings of the chambers while they are being stressed, and consequently to obtain greater thrust of fluid from one chamber towards the other chamber in the same set.

The invention is not limited in any way to the embodiments and implementations described above. Other embodiments enable similar results to be obtained.

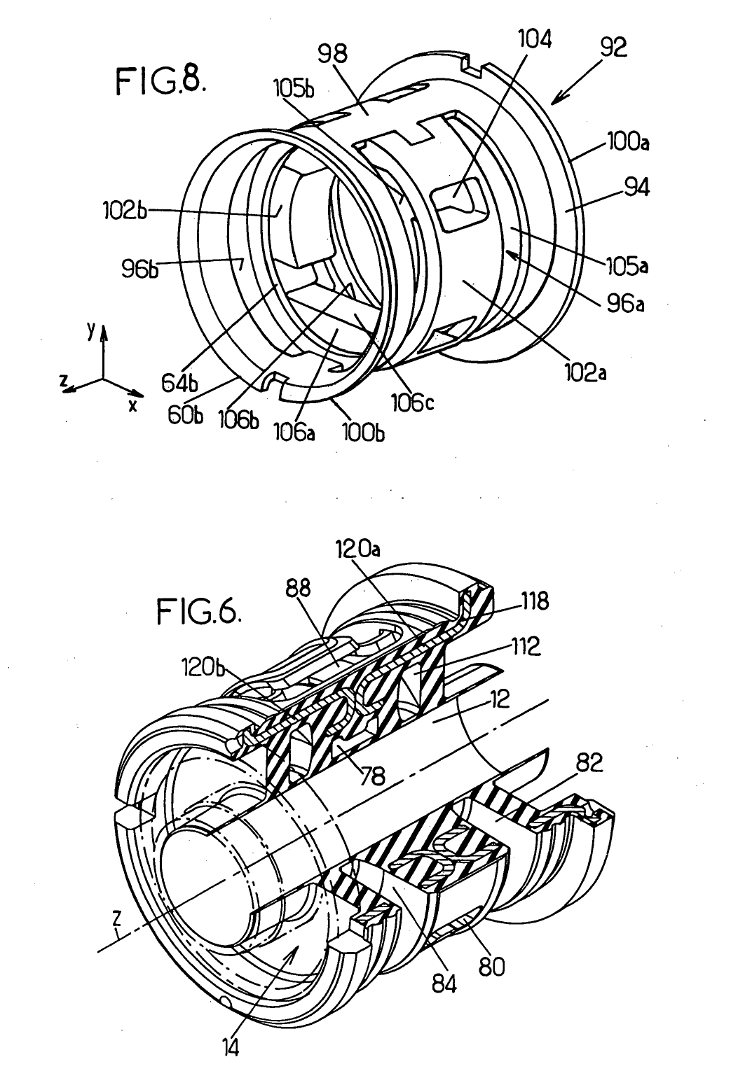

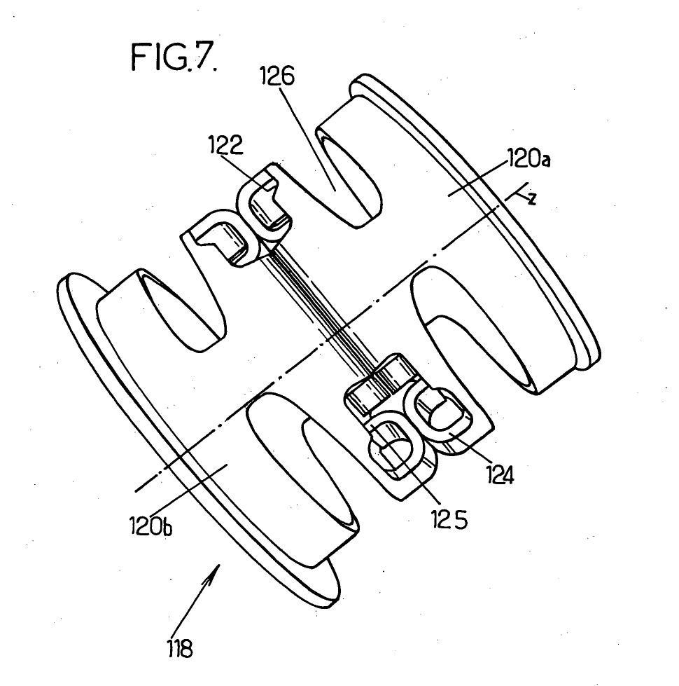

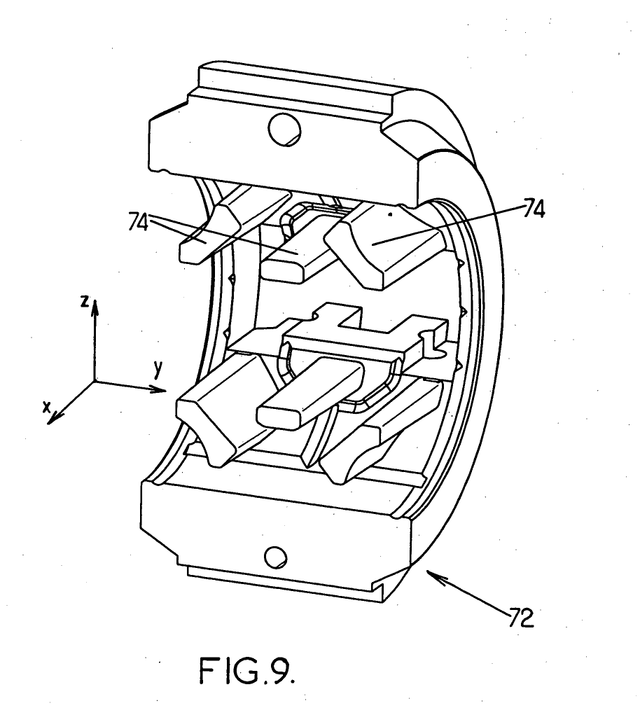

A second embodiment of the device is shown in FIGS. 6 to 8. FIG. 6 is a section view on two perpendicular planes of an antivibration device constituting the second embodiment of the invention. FIG. 7 is a perspective view of the window strength member integrated in the FIG. 6 device. FIG. 8 shows another window strength member that could be used in a device of the type shown in FIG. 6.

The device shown in part in FIG. 6 comprises an inner strength member and an outer strength member (not shown), together with a window strength member 118 and an elastomer body 14. More precisely, the device includes in the elastomer body 14 two sets of two chambers 78 and 80 and 82 and 84, the chambers in any one set being interconnected by at least one duct. A first set 78 and 80 serves to damp vibration in the radial direction, and is referred to below as the radial set. The other set, referred to as the axial set, serves to damp vibration in the axial direction, i.e. parallel to the longitudinal axis Z.

The chambers 78 and 80 of the radial set are disposed in a midplane perpendicular to the longitudinal axis Z. The radial set is substantially identical to that of the first embodiment. It comprises circumferentially-extending chambers opening out into the cylindrical surface of the elastomer body 14, and presenting respective openings that are substantially circular in shape.

The axial set comprises two through parallel chambers 82 and 84 that are disposed towards the longitudinal end of the device and that occupy two distal planes parallel to the midplane. These chambers are interconnected by two ducts, only one of which 88 is visible in FIG. 6. Alternatively, they could be interconnected by a single duct.

The chambers 82 and 84 open out into the cylindrical surface of the elastomer body 14 via openings that are partially circular, i.e. that are in the form of a circular arc about the longitudinal axis Z of the elastomer body 14. Each opening then presents a greater area because of the circularly-arcuate shape, so the corresponding chamber is more easily deformable. This enables vibration to be damped more strongly at the resonant frequency of the duct interconnecting the two chambers 82 and 84.

As shown in FIG. 7, the window strength member 118 is made by assembling together two identical plate elements 120a and 120b. Each plate element 120a and 120b is made by stamping and presents a hollow cylindrical shape extending longitudinally substantially parallel to the axis Z. The plate elements 120a and 120b are assembled together via respective first longitudinal ends so that the length of the window strength member is slightly longer than the length of the outer strength member. Each strength member presents a second longitudinal end that is curved so that, after assembly, the outer strength member is blocked on the window strength member. In addition, the plate elements present cutouts 122 and swaged edges 124.

The cutouts 122 define the sections of the chambers 78 and 80 of the radial set. The swaged edges 124 enable faces to be obtained that are facing each other, via which the plate elements 120a and 120b are assembled together by welding. In addition, the swaged edges 124 are U-shaped, with at least one limb 125 of each U-shape being directed parallel to the longitudinal axis Z so as to form bearing zones capable of exerting pressure on the deformable elastomer walls of the chambers in the radial and axial sets, thereby increasing the flow amplitude of fluid from one chamber to the other. The elastomer walls of the chambers 78 and 80 and 82 and 84 adjacent to the bearing zones can extend in a direction parallel to the direction of the surface of the bearing zones in order to increase effectiveness in axial and radial damping.

In addition, each plate element 120a, 120b includes openings or windows 126 that are partially circular, made in a midplane perpendicular to the longitudinal axis Z and corresponding to the openings of the chambers 82 and 84 of the axial set.

Each chamber in a given set is connected to at least one duct as described for the first embodiment. The chambers 82 and 84 of the axial set located towards the longitudinal ends of the device are interconnected by at least one duct 88 extending longitudinally between the two chambers 82 and 84. In a variant of the invention, the chambers 82 and 84 can communicate with each other via two ducts disposed adjacent to each other and separated by an elastomer bead. These two ducts serve to allow fluid to pass from one chamber to the other.

The ducts interconnecting the chambers 78 and 80 and 82 and 84 are defined in part by the outer strength member 36, by the elastomer walls 14 formed when molding the device, and by the plate elements 120a, 120b that are optionally covered in an elastomer layer. The ducts are disposed parallel to the longitudinal axis Z or in a plane perpendicular to the longitudinal axis in order to damp vibration respectively in an axial direction and in a radial direction.

The device constituting the second embodiment operates in substantially the same manner as the device constituting the first embodiment.

When the inner and outer strength members 12 and 36 are subjected to stresses, the chambers 78 and 80 and 82 and 84 of the first and second sets deform, thereby causing fluid to be displaced from one chamber to the other via the ducts 88.

In the second embodiment, the sections of the chambers 82 and 84 in the axial set are greater, so the deformation of the sections and the volumes of the chambers 82 and 84 is thus likewise greater. This increases the force with which fluid is thrust from a first chamber to the other chamber by the fluid being compressed in the first chamber. At the resonant frequency of the duct, damping is thus greater than in the first embodiment.

In addition, in each chamber 82 and 84 of the axial set, the device in the second embodiment presents a transverse passage 112 defined by the inner strength member 12 and by the window strength member 118, and open to each of the chambers 82 and 84. This passage acts as an inner duct through which the fluid passes. The device thus presents damping ability at a frequency that is different from the above-described resonant frequency of the ducts interconnecting the chambers 82 and 84, which corresponds to the resonant frequency for fluid flow in the passage 112.

The device described in the above paragraph is made as follows. The plates 120a and 120b of the window strength member are made by stamping and they are then assembled together by welding on the swaged portions 124. Thereafter, the inner strength member 12 and the outer strength member 36 are placed in a mold prior to injecting elastomer.

The mold comprises two semicylindrical shells 114 carrying two fingers 116a and 116b as shown in FIG. 10, and also two fingers in the form of half-rings 117a and 117b so as to form the chambers 82 and 84 of the axial set.

After injecting elastomer, the half-shells 114 are withdrawn parallel to the transverse direction X. Draft angles are provided to make withdrawal easy. Thereafter, two inner membranes produced by the elastomer that has flowed between two facing fingers 116 during molding are situated in each of the chambers 82 and 84 of the second set. These membranes can subdivide the chambers 82 and 84 into two portions, but they must present sufficient ability to deform to allow the fluid to flow in the ducts. When the membranes are pierced, the device has single chambers 82 and 84, each extending across one of the longitudinal ends of the device. Such a thin membrane can also become punctured on its own after the device has been subjected to a small amount of physical testing. The pierced membrane then forms the above-mentioned inner passages 112. Similarly, between the two fingers 116a and 116b of the mold for making the device in the first embodiment, two membranes may be created during the molding step and they may be punctured subsequently.

In a variant of the second embodiment, as shown in FIG. 8, the window strength member 92 of the device constituting the second embodiment presents a metal structure 94 formed by a hollow cylinder of central axis parallel to the longitudinal axis Z. The metal structure presents two openings 96a and 96b in its cylindrical structure, defined by two longitudinal arms 98.

Two plastics material plate elements 102a and 102b in the form of circular arcs are fitted onto the arms 98. As shown, these plate elements 102a and 102b are diametrically opposite when they are in place on the longitudinal arms 98 of the window strength member 92, and they form a circle of diameter significantly smaller than the outside diameter of the circular ends 100a, 100b. Each element 102a, 102b presents windows 104, each constituting an opening for a chamber of the radial set through the window strength member 92.

Assembling the plates 102a and 102b of plastics material with the metal structure 94 serves to form chamber openings 105a, 105b corresponding to the chambers of the axial set.

From the above description, it is possible to select shapes for the plastics material plate elements 102a, 102b and to position them as a function of the shape desired for the window strength member 92, which shape may be complex to a greater or lesser extent. The plate elements 102a and 102b made of plastics material can present one or more windows 104.

The plastics material plate elements 102a and 102b also include bearing zones 106a, 106b, and 106c formed by projecting portions extending towards the inside of the window strength member 92 and adjacent to the chambers 78 and 80 and 82 and 84 so as to exert pressure on the chambers in order to modify the flow of fluid therein. The surfaces 106a and 106b of the bearing zones adjacent to the chambers 82 and 84 of the axial set are perpendicular to the longitudinal axis Z, and the surfaces 106c of the bearing zones adjacent to the chambers 78 and 80 of the radial set are perpendicular to the transverse axis Y.

The plastics material plate elements 102 are mounted on the metal structure 94 by snap-fastening, thus making it possible to obtain a window strength member 92 that is capable of being modular, since it is easy to change the plate elements 102a, 102b.

The resulting window strength member 92 thus presents the same windows as that described above, and is applicable to the same antivibration devices as described for the second embodiment.

It should be observed that during the molding operation, the shape of the sections of the chambers 82 and 84 can be varied depending on the shapes of the recesses formed by the fingers 116.

In a variant that can be applied to both embodiments, the device includes rigid washers on the bottom and top portions of the elastomer body (one washer shown in chain-dotted lines in FIG. 6), that are secured on the inner strength member as a tight fit. These washers are made of metal and serve to increase the pressure exerted on the axial set of chambers, and thus to increase their deformation, so as to improve the effectiveness of damping.

In another variant of the invention, the window strength member can be made entirely out of rigid plastics material by molding. This enables a variety of shapes to be obtained, at a manufacturing cost that is lower than when using a metal strength member.

1. A hydraulic antivibration device comprising an inner strength member and an outer strength member that are coaxial about a longitudinal axis Z, an elastomer body disposed between the inner and outer strength members and interconnecting them, said body being secured to the inner strength member and co-operating with the outer strength member to form a leaktight assembly, the elastomer body including at least two sets of two hydraulic chambers, the chambers in any one set communicating with one another via a duct in which a fluid flows, at least one of the sets being for damping vibration in a direction selected from a radial direction and an axial direction, wherein:
it includes a window strength member disposed inside the elastomer body and comprising at least one plate element close to the outer strength member; and
the ducts interconnect pairs of chambers of each set over at least a portion situated between a plate element of the window strength member and the outer strength member, and comprise walls formed by the elastomer body.

2. A device according to claim 1, wherein the chambers are rectilinear and pass through the elastomer body in a direction that is parallel to a transverse axis X perpendicular to the longitudinal axis Z.

3. A device according to claim 1, wherein the window strength member presents windows defining a section of the chambers.

4. A device according to claim 1, the device comprising:
at least one first set of two chambers interconnected by a first duct extending essentially parallel to the longitudinal axis Z, for damping vibration in the axial direction;
at least one second set of two chambers interconnected by a second duct extending essentially in a plane perpendicular to the longitudinal axis Z for damping vibration in a radial direction; and
two distinct plate elements, the first and second ducts each passing between a distinct plate element and the outer strength member.

5. A device according to claim 1, wherein the first and second ducts are diametrically opposite each other.

6. A device according to claim 1, wherein elastomer beads run along at least a portion of each duct, in order to reinforce the sealing properties of the duct.

7. A device according to claim 1, wherein each chamber of a first set extends longitudinally parallel to a midplane and perpendicularly to the longitudinal axis Z, and is symmetrical to the other chamber about said midplane, and each chamber of a second set extends longitudinally essentially in the midplane, and is symmetrical to the other chamber about the axis Z.

8. A device according to claim 1, wherein it has two sets of chambers for damping in an axial direction, these two sets being diametrically opposite and disposed in the vicinity of the longitudinal ends of the device, the ducts interconnecting the two chambers in each set extending essentially along the longitudinal axis.

9. A device according to claim 1, wherein the window strength member comprises at least two semicylindrical metal plates assembled together by staking.

10. A device according to claim 1, wherein the window strength member includes a metal structure on which plate elements made of plastics material are fitted.

11. A device according to claim 1, wherein the window strength member comprises two cylindrical metal plates assembled together by welding.

12. A device according to claim 1, wherein the window strength member presents at least one U-shaped bearing zone having limbs adjacent to the chambers.

13. A device according to claim 12, wherein the bearing zone is formed by projecting portions of the plastics material plate elements that are directed towards the inside.

14. A device according to claim 1, wherein the strength member is made entirely out of plastics material.

15. A method of manufacturing a device according to claim 1, wherein a window strength member is placed in a mold together with the inner strength member, and that the mold is made up of at least two parts, at least one of the parts including at least one finger, and, on being closed, the mold is adapted to form at least two chamber-forming recesses and at least one duct interconnecting the two chambers, said duct having at least one portion situated between the window strength member and the outer strength member.

16. A method of manufacture according to claim 15, wherein it includes an unmolding operation during which the two mold parts are moved apart along a direction perpendicular to the axial direction.
